(19) United States
(12) Patent Application Publication
(10) Pub. No.: US 2021/0011494 A1
(43) Pub. Date: Jan. 14, 2021

(54) MULTI-NODE UNMANNED AERIAL VEHICLE (UAV) CONTROL

(71) Applicant: Atlas Dynamic Limited, Dublin (IE)

(72) Inventor: Romans Artemjonoks, Riga (LV)

(21) Appl. No.: 16/790,727

(22) Filed: Feb. 13, 2020

Related U.S. Application Data
(60) Provisional application No. 62/804,904, filed on Feb. 13, 2019.

(51) Int. Cl. G05D 1/10; B64C 39/02

(52) U.S. Cl. CPC G05D 1/1064; B64C 39/024; G05D 1/0022; B64C 2201/14; B64C 2201/027

(57) ABSTRACT

Systems and methods are disclosed for multi-node unmanned aerial vehicle (UAV) control. In one implementation, one or more commands are received at a first UAV. A location update associated with a second UAV is received at the first UAV. The location update is processed to compute a location of the first UAV in relation to the second UAV. Based on the computed location of the first UAV in relation to the second UAV one or more operations are initiated in relation to the one or more commands.

### CROSS-REFERENCE TO RELATED APPLICATION

This application is related to and claims the benefit of U.S. Patent Application No. 62/804,904, filed Feb. 13, 2019, which is incorporated herein by reference in its entirety.

### TECHNICAL FIELD

Aspects and implementations of the present disclosure relate to data processing, and more specifically, to multi-node unmanned aerial vehicle (UAV) control.

### BACKGROUND

Unmanned vehicles (e.g., unmanned aerial vehicles (UAVs)) can be used for a wide variety of tasks. Such vehicles can be controlled in various ways.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system, in accordance with an example embodiment.

FIG. 2 depicts further aspects and implementations of the described technologies.

FIGS. 3A-3B depict further aspects and implementations of the described technologies.

FIG. 3C is a flow chart illustrating a method, in accordance with example embodiments, for multi-node unmanned aerial vehicle (UAV) control.

FIG. 4 depicts further aspects and implementations of the described technologies.

FIG. 5 depicts further aspects and implementations of the described technologies.

FIG. 6 depicts further aspects and implementations of the described technologies.

FIG. 7 depicts further aspects and implementations of the described technologies.

FIGS. 8A-8D depict various user interfaces that depict and/or reflect further aspects and implementations of the described technologies.

FIGS. 9A-9D depict various user interfaces that depict and/or reflect further aspects and implementations of the described technologies.

FIGS. 10A-10D depict various user interfaces that depict and/or reflect further aspects and implementations of the described technologies.

FIG. 11 is a block diagram illustrating components of a machine able to read instructions from a machine-readable medium and perform any of the methodologies discussed herein, according to an example embodiment.

### DETAILED DESCRIPTION

Aspects and implementations of the present disclosure are directed to multi-node unmanned aerial vehicle (UAV) control.

Existing technologies enable users to configure and/or control the operation of single UAVs. However, such technologies are inherently limited and sub-optimal for scenarios that may benefit from multiple UAVs operating simultaneously. Additionally, existing technologies are limited by the relatively short range that a UAV must remain in relation to a control device in order to maintain a connection be operated by such a device.

Accordingly, described herein in various implementations enable multi-node unmanned aerial vehicle (UAV) control. Using the described technologies, multiple UAVs can be configured as interconnected nodes in relation to one another. Such configurations and topologies can enable additional features and functionalities that provide operational advantages and efficiencies, particularly in scenarios in which multiple UAVs can be deployed simultaneously, as described herein.

It can therefore be appreciated that the described technologies are directed to and address specific technical challenges and longstanding deficiencies in multiple technical areas, including but not limited to including but not limited to UAVs, multi-device control, and user interfaces. As described in detail herein, the disclosed technologies provide specific, technical solutions to the referenced technical challenges and unmet needs in the referenced technical fields and provide numerous advantages and improvements upon conventional approaches. Additionally, in various implementations one or more of the hardware elements, components, etc., referenced herein operate to enable, improve, and/or enhance the described technologies, such as in a manner described herein.

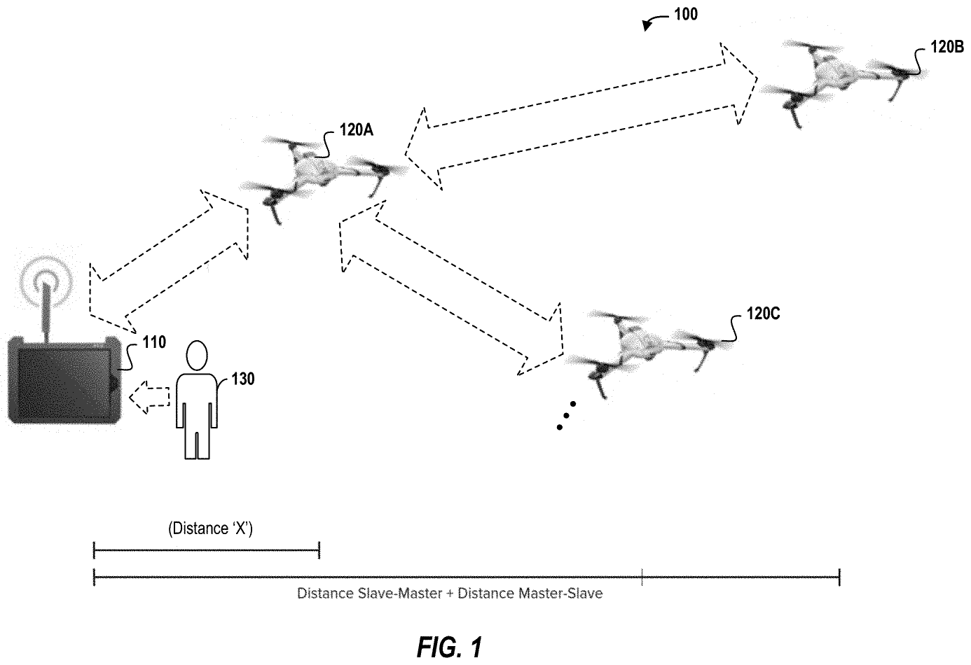

FIG. 1 depicts system 100, in accordance with some implementations. As shown, the system 100 includes components such as device 110 and UAVs 120A, 120B, 120C, etc. These various elements or components can be connected to one another directly and/or via a network (e.g., a public or private network such as the Internet, a LAN, WAN, etc.). User 130 can be a human user who interacts with device 110. For example, user 130 can provide various inputs (e.g., via an input device/nterface such as a keyboard, mouse, touchscreen, etc.) to device 110. Device 110 can also display, project, and/or otherwise provide content to user 130 (e.g., via output components such as a display screen, speaker, etc.).

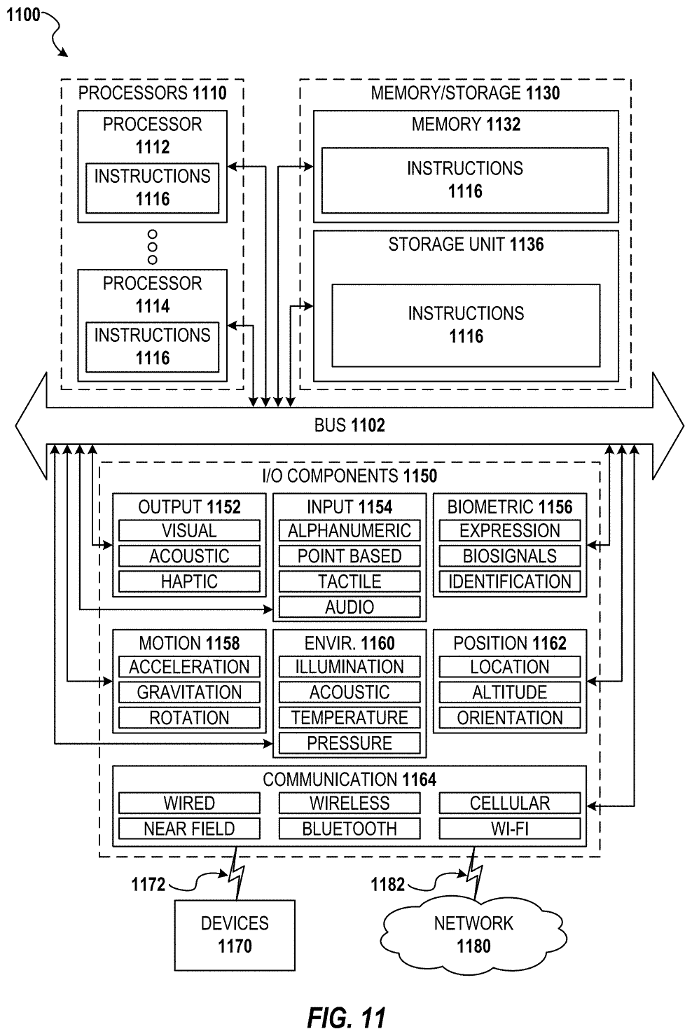

Device 110 can be a personal computer, a mobile device, a smartphone, a tablet computer, a laptop computer, a server, a smartwatch, a wearable device, an in-vehicle computer/system, any combination of the above, or any other such computing device capable of implementing the various features described herein. Such a device can include various applications, programs, modules, or other executable instructions (e.g., stored in memory 1130 as depicted in FIG. 11 and described below). Such applications, etc., when executed (e.g., by processors 1110 as depicted in FIG. 11 and described below), can configure/enable the device to interact with, provide content to, and/or otherwise perform operations on behalf of user 130. Additionally, in certain implementations such applications, etc., can configure various elements of system 100 to perform other operations, such as those described herein.

It should be noted that while the referenced application(s), etc. are depicted and/or described as operating on device 110, this is only for the sake of clarity. However, in other implementations such elements can also be implemented on other devices/machines. For example, in lieu of executing locally at device 110, aspects of the referenced application(s), etc. can be implemented remotely (e.g., on a server device or within a cloud service or framework).

Moreover, in various implementations, aspects of the described technologies can also be implemented at one or more of UAVs 120, as described herein. For example, as described herein, UAV 120A (e.g., as depicted in FIG. 1) can include a processor, memory, sensors, and/or one or more elements depicted in FIG. 11 and/or described herein. Such UAVs can further execute applications and perform various other operations, as described herein. Doing so can, for example, enable a local UAV to generate a real-time three-dimensional map of its location (e.g., in relation to the locations of other UAVs), and perform various other operations, as described herein. Such functionality can be advantageous in multiple scenarios and settings, including by enabling the autonomous operation of such UAVs while ensuring safety and avoiding collisions among them. These and other described features, as implemented with respect to one or more particular machine(s) such as the referenced UAVs, can improve the functioning of such machine(s) and/or otherwise enhance numerous technologies including those enabling the autonomous control, management, and deployment of UAVs and related operations, as described herein.

As used herein, the term “configured” encompasses its plain and ordinary meaning. In one example, a machine is configured to carry out a method by having software code for that method stored in a memory that is accessible to the processor(s) of the machine. The processor(s) access the memory to implement the method. In another example, the instructions for carrying out the method are hard-wired into the processor(s). In yet another example, a portion of the instructions are hard-wired, and a portion of the instructions are stored as software code in the memory.

In certain implementations, various aspects of the described technologies include methods performed by processing logic that can comprise hardware (circuitry, dedicated logic, etc.), software (such as is run on a computing device such as those described herein), or a combination of both. In one implementation, such method(s) are performed by one or more elements depicted and/or described in relation to FIG. 1 (including but not limited to device 110, UAV(s) 120, etc.), while in some other implementations, the described operations can be performed by another machine or machines.

For simplicity of explanation, methods are described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the disclosed methods are capable of being stored on an article of manufacture to facilitate transporting and transferring such methods to computing devices. The term article of manufacture, as used herein, is intended to encompass a computer program accessible from any computer-readable device or storage media.

In certain implementations, device 110 can also include and/or incorporate various sensors and/or communications interfaces (including but not limited to those depicted in FIG. 11 and/or described herein). Examples of such sensors include but are not limited to: accelerometer, gyroscope, compass, GPS, haptic sensors (e.g., touchscreen, buttons, etc.), microphone, camera, etc. Examples of such communication interfaces include but are not limited to cellular (e.g., 3G, 4G, etc.) interface(s), Bluetooth interface, WiFi interface, USB interface, NFC interface, satellite communication interface, infrared interface, etc.

Unmanned vehicle(s) 120 (e.g., a UAV or ‘drone’) may include multi-rotor aircrafts such as helicopters, tricopters, quadcopters, hexacopters, octocopters, and the like. UAV 120 may be used in a wide variety of applications including but not limited to remote sensing, aerial surveillance, oil, gas and mineral exploration and production, transportation, scientific research, aerial photography or videography, mapping, disaster reporting, search and rescue, mapping, power line patrol, weather reporting and/or prediction, traffic detection and reporting.

It should be understood that one or more of the referenced vehicle(s) 120 is/are described herein as a UAV for the sake of illustration. Accordingly, in other implementations the described technologies can be applied with respect to any number of other objects, devices, etc. For example, in addition to aircraft (such as UAVs, fixed-wing aircraft such as airplanes, rotary-wing aircraft such as helicopters, etc.), the described technologies can also be implemented with respect to water vehicles (e.g., boats, ships, submarines, etc.) or motor vehicles (e.g., cars, trucks, etc.).

In various embodiments, UAV 120 can be autonomously-controlled, e.g., by an onboard controller or processor, remotely-controlled by a remote device (e.g., a ground station or a hand-held remote-control device such as device 110), or jointly controlled by both. In some embodiments, the UAV may be configured to carry a payload device such as a camera or a video camera via a carrier. The payload device may be used to capture images of surrounding environment, collect samples, or perform other tasks.

Additionally, in certain implementations UAV 120 can include various elements of and/or functionalities associated with device 110. For example, UAV 120 can include or integrate processor(s), memory, sensors, communication interfaces, and/or other such elements depicted in FIG. 11 and/or described herein in relation to device 110. Moreover, in certain implementations UAV 120 can include and/or be configured to execute various application(s), etc. such as those that enable the UAV to generate and/or provide instructions to other UAVs/devices, and/or perform other operations such as those described herein.

In certain implementations, multiple UAV's can be configured to communicate with and/or control one another in various arrangements. For example, as shown in FIG. 1, one UAV (e.g., UAV 120A, operating as a ‘master’ node) can be configured to control and/or otherwise transmit commands to other UAV(s) (e.g., UAVs 120B and 120C, operating as ‘slave’ nodes, as shown in FIG. 1) and/or device(s) (e.g., device 110). In certain implementations, the connection between such node(s) can be implemented in part using a software layer that enables exchange of telemetry information (location, height, battery status, etc.), video streams, etc. (e.g., from one UAV to another), as described herein.

In certain implementations, the described technologies can be configured to enable an automated safety air map with respect to multiple UAVs. For example, as multiple UAVs are in flight, such UAVs can exchange telemetry information, inputs or data received at various sensors (GPS, altitude, etc.), etc. Based on the respective locations of each UAV in space, positions, spacing, etc., can be computed (e.g., for each respective UAV) to ensure the UAVs do not collide, hit each other, etc., as described herein.

By way of further illustration, in certain implementations, one UAV can utilize the received location(s) of other UAV(s) to determine the position/location to which it should (or should not) travel. For example, as shown in FIG. 1, upon receiving the respective locations of UAV 120B and UAV 120C, UAV 120A can determine the position, location, etc., to which it should (or should not) travel. Moreover, by configuring the described UAVs to exchange such data between them, an “air map” of a number of UAVs can be generated. Using such information, a base station controlling them (e.g., device 110) can further configure or control such UAVs in a manner that ensures that appropriate distance(s), height differences, etc., are maintained between UAVs. Alternatively, in certain implementations the respective UAVs can create such a map and/or perform such operation(s) locally (e.g., in conjunction with an application executing at the UAV), as described herein. Doing so can be advantageous, for example, in order to create an automatic safety layer among the referenced UAVs. Additionally, the described technologies can further provide the user with real-time information, status, etc., with respect to the various UAVs. Additionally, various commands can be generated (e.g., in an automatic/automated fashion) to configure the referenced UAVs to ensure they remain within appropriate safety boundaries.

Additionally, in certain implementations the described technologies can extend the communication range across multiple devices. Doing so can, for example, enable devices to communicate with one another across distances that may not otherwise be possible using existing (direct) communication protocols. For example, as shown in FIG. 1, device 110 (e.g., a control device) may only be capable of communicating directly with UAV 120A via certain communication protocols (e.g., radio, Bluetooth, etc.) within a defined distance (e.g., distance ‘X,’ as shown). Accordingly, other devices (e.g., UAV 120B) may be outside the range of direct communication with device 110B. However, by implementing the described technologies, device 110 can transmit commands and/or otherwise communicate with UAV 120B via UAV 120A. In doing so, the described devices/UAVs can communicate with one another across distances that may not otherwise be possible using existing (direct) communication protocols.

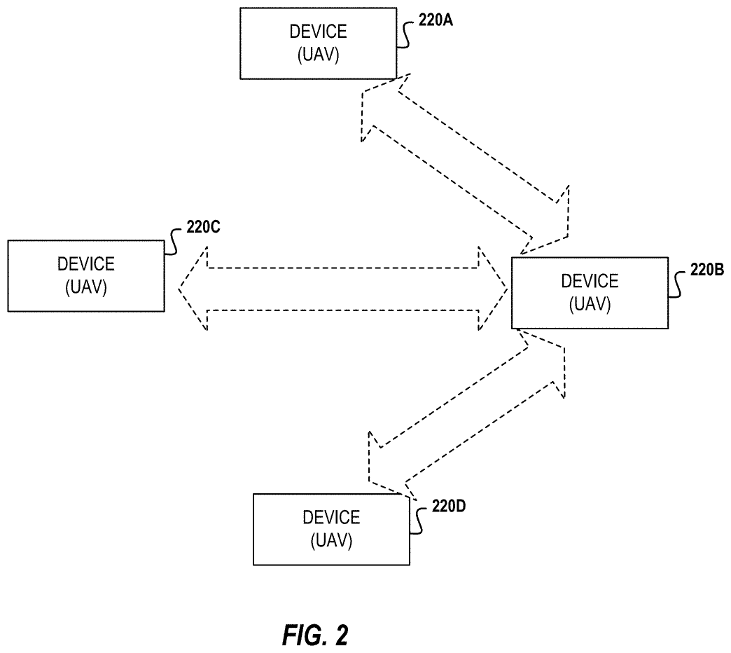

Another example configuration of the described technologies is shown in FIG. 2. As shown in FIG. 2, multiple UAVs (here, devices 220A, 220C, and 220D, which can operate as ‘slave’ nodes) can communicate with one another via device 220B (the ‘master’ node). Doing so can extend the communication range across devices and enable devices to communicate with one another across distances that may not otherwise be possible using existing (direct) communication protocols.

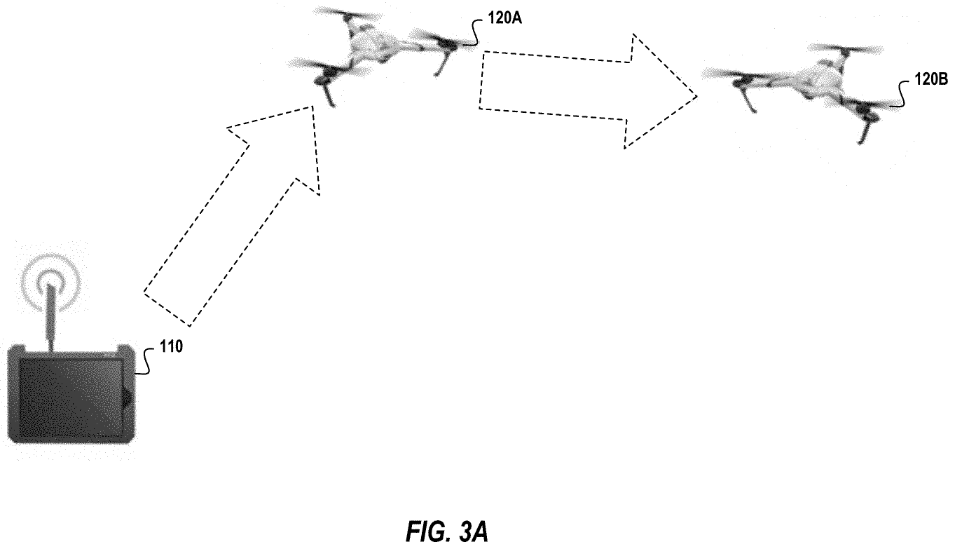

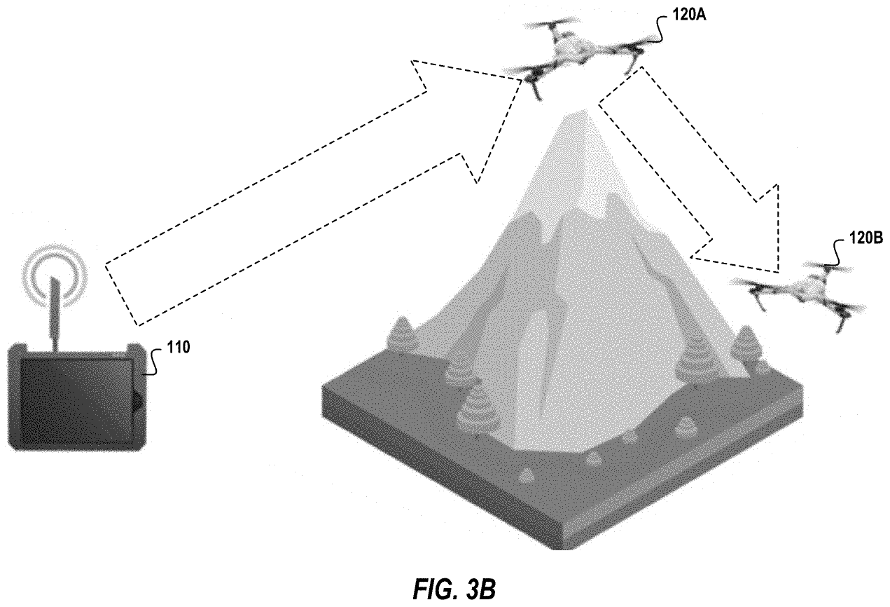

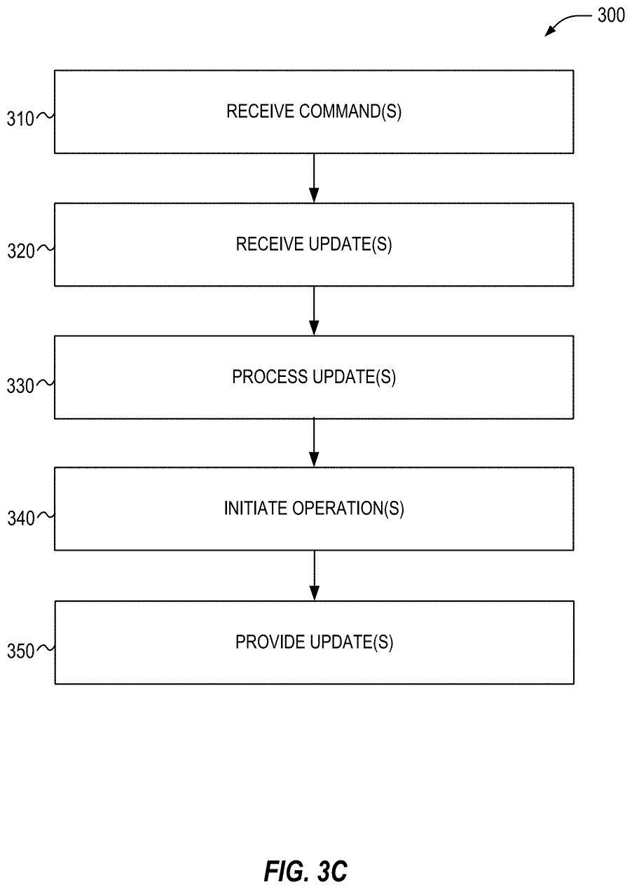

FIGS. 3A and 3B depict other scenarios in which device 110 can transmit command(s) to UAV 120B (which may otherwise be outside of direct communication range with device 110, as in FIG. 3A, or obscured by obstacles as in FIG. 3B) via UAV 120A.

FIG. 3C is a flow chart illustrating a method 300, according to an example embodiment, for multi-node unmanned aerial vehicle (UAV) control. The method is performed by processing logic that can comprise hardware (circuitry, dedicated logic, etc.), software (such as is run on a computing device such as those described herein), or any combination thereof. In one implementation, the method 300 is performed by one or more elements depicted and/or described in relation to FIG. 1 (including but not limited to device 110 and/or one or more UAV 120), while in some other implementations, the one or more blocks of FIG. 3C can be performed by another machine or machines.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At operation 310, one or more commands are received. In certain implementations, such command(s) can be received at a first UAV. For example, as shown in FIG. 1, UAV 120A can receive command(s) originating from device 110.

In certain implementations, such commands directed to one or more UAV(s). For example, as described herein, such command(s) can include or reflect a mission, task, etc., that can pertain and/or be directed to multiple UAV(s). By way of illustration, such command(s) can include a surveillance mission that directs multiple UAVs to perform surveillance over a geographic area, region, etc., as described herein.

In certain implementations, such command(s) can be processed. In doing so, one or more instructions can be generated. In certain implementations, such instructions can pertain to various specific UAVs. For example, upon receiving a command reflecting a mission that may be directed to or involve multiple UAVs, such a command can be processed to generate instructions to be directed to individual UAVs. In certain implementations, such instructions can be generated via a distributed application, e.g., that executes on one or more of the referenced UAV(s). By way of illustration, as depicted in FIG. 1, UAV 120A can receive command(s) corresponding to a mission that may involve multiple UAVs. UAV 120A can process such command(s) (e.g., via a distributed application) to generate instruction(s), e.g., which reflect elements or aspects of the referenced mission to be performed by individual UAVs. UAV 120A can then distribute such instruction(s) to the respective UAVs (e.g., UAVs 120B and 120C, as shown in FIG. 1). In doing so, the referenced UAVs can autonomously mange the distribution of elements or aspects of the referenced mission to individual UAVs (e.g., without necessitating manual configuration, input, monitoring, or control of such UAVs).

At operation 320, an update (e.g., a location update) can be received. In certain implementations, such a location update can be received at the first UAV. Additionally, in certain implementations such an updated can be associated with and/or received from a second UAV and/or one or more other UAVs (e.g., a third UAV, etc.). in certain implementations, such an update can include or reflect input(s) or other information originating from various sensors (e.g., of the second UAV, third UAV, etc.). Such updates, inputs, etc., can reflect, for example, telemetry information, sensor inputs, etc., originating from such UAVs, and can reflect the location of such UAVs (e.g., geographic coordinates, altitude information) and/or other updates (e.g., battery status, video content, etc.).

In certain implementations, the referenced update(s) can be received at one UAV from other UAVs that are within communication range (e.g., within range of direct radio, Bluetooth, etc. communication). For example, as shown in FIG. 1 and described herein, UAV 120A can receive updates from UAVs 120B and 120C (which may within communication range).

At operation 330, the update(s) (e.g., as received at 320) can be processed. In doing so, a location of the first UAV can be computed or otherwise determined. In certain implementations, such a location determination of one UAV can be computed in relation to other UAVs (e.g., a second UAV, third UAV, etc.). For example, as depicted in FIG. 1 and described herein. UAV 120A can receive location updates from UAVs 120B and 120C. Based on such update(s), UAV 120A can determine its own location (e.g., three-dimensional location) relative to the location(s) of UAV(s) 120B and/or 120C. Doing so can further include and/or enable the computation of a real-time map (e.g., an ‘air map’) reflecting a location of one UAV in relation to one or more respective locations of one or more other UAVs. For example, as depicted in FIG. 1 and described herein, UAV 120A can compute an maintain a real-time mapping of its own location in relation to the locations of UAVs 120B, 120C, etc. It should be understood that, in certain implementations, such computations, determinations, etc., can be implemented locally (e.g., at UAV 120).

Accordingly, UAV 120 can, for example, independently maintain a real-time map of its own location in relation to the locations of other UAVs around it. Doing so can be advantageous for numerous reasons, including by enabling the referenced UAVs to operate autonomously and ensure such autonomous operations are conducted safely (e.g., without the risk of collision between UAVs). Additionally, by implementing such features locally (e.g., in lieu of involvement of device 110), the efficiency and accuracy of such operations can be improved. Moreover, by operating autonomously, safe and efficient operation of the referenced UAVs can be ensured, even in scenarios in which communication between UAV 120A and device 110 may be interrupted.

At operation 340, one or more operations can be initiated. In certain implementations, such operation(s) can be initiated in relation to the one or more commands (e.g., the commands received at 310, such as a UAV mission or portions/segments thereof). Additionally, in certain implementations such operation(s) can be initiated based on the computed location of the first UAV in relation to other UAV(s) (e.g., as computed/determined at 330).

For example, as depicted in FIG. 1 and described herein, based on the computed or determined location of UAV 120A (e.g., in relation to UAVs 120B, 120C, etc.), the described technologies can initiate various operation(s). Such operation(s) can include, for example, configuring UAV 120A in a manner that prevents it from colliding with other UAVs (e.g., UAVs 120B, 120C, etc.). By way of further illustration, such operation(s) can include initiating various other safety operations, e.g., with respect to UAVs 120A, 120B, 120C, etc.

By way of illustration, a command or mission can be directed to multiple UAVs, e.g., to perform surveillance on a specific area. As described herein, aspects or elements of such a command or mission can be further distributed to individual UAVs. Such UAVs may operate independently or autonomously in performing aspects of such a mission (e.g., by performing automated surveillance on different portions of the specified area). However, in certain scenarios the independent operation of such UAVs may create a risk of collision between such UAVs (and/or other safety risks). Accordingly, the described technologies can enable the respective UAVs to monitor the location(s) of other proximate UAVs, and can further initiate operations that can, for example, adjust or override other instructions, such that the referenced collisions or other hazards can be avoided. For example, while perming a given instruction, upon determining that it is approaching another UAV (using the described technologies), the performance of such an instruction can be modified or overridden (e.g., to avoid collision, etc.).

At operation 350, an update is provided. In certain implementations, such an update can include or reflect location information, telemetry information, sensor inputs, etc., originating from such a UAV. For example, as described herein, UAV 120A as shown in FIG. 1 can provide updates to other UAV(s) 120B, 120C, etc. Such updates can include or reflect the location of such a UAV (e.g., geographic coordinates, altitude information) and/or other updates associated with the UAV (e.g., battery status, video content, etc.). Additionally, in certain implementations such update(s) can include or reflect updates or other information received from other UAVs. For example, UAV 120A can provide update(s) to UAV 120B that reflect updates received from UAV 120C, as described herein. In doing so, the described technologies can improve the functioning of such machine(s) and/or otherwise enhance numerous technologies including those enabling the autonomous control, management, and deployment of UAVs and related operations, as described herein.

By way of further illustration, in certain implementations the described technologies can configure the described UAVs to coordinate with one another to perform various collective operations, missions, etc. For example, a collective commandrnstruction can be transmitted (e.g., from device 110) to multiple UAVs, e.g., to monitor or scan an area, stay above a defined target, etc. The described technologies can process such instruction(s), generate one or more operation segments, and distribute such segments to different UAVs (e.g., such that one UAV performs one segment of the mission in one location, while another UAV performs another segment in another location).

Additionally, in certain implementations the described technologies can be configured to distribute such segments to different UAVs based on various criteria or capabilities, such as the capabilities of different UAVs, their location, their battery status, their payloads, respective locations, battery status, etc. In doing so, control unit or device 110 can also be presented with the respective mission segments and can further monitor the status of the performance of each mission segment by respective UAVs.

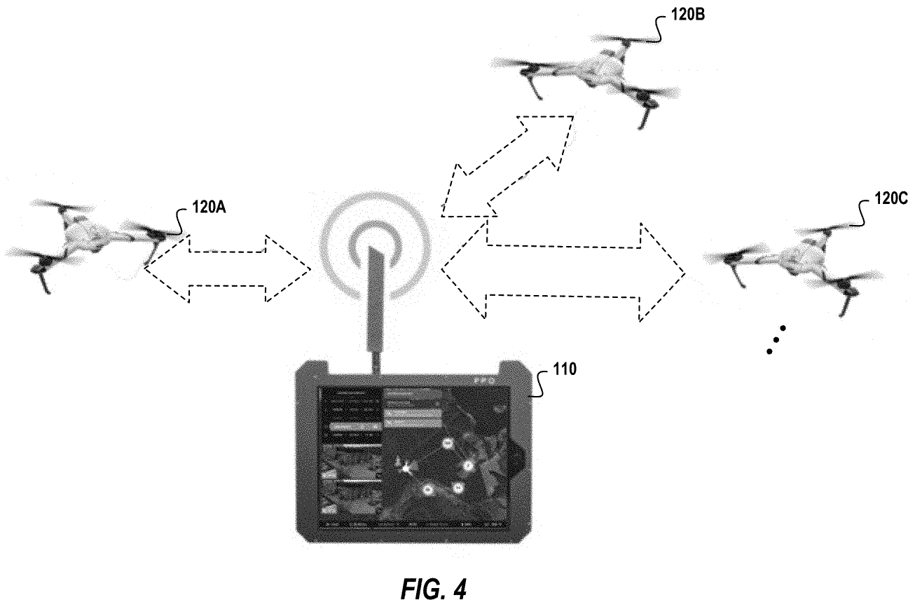

For example, FIG. 4 depicts a scenario in which device 110 (e.g., a control unit or other such device configured to control and/or monitor the operations, status, etc., of multiple UAVs 120) receives real-time information (e.g., video, telemetry, and sensor data) from multiple UAVs, such as UAV 120A, UAV 120B, UAV 120C, etc., as shown. Such received information, status, etc., can be presented, depicted, etc. via various interfaces, such as an integrated screen or touchscreen interface of device 110, as shown. In doing so, real-time information, status, etc. of multiple UAVs 120A-C can be presented within a single interface. Moreover, in lieu of needing multiple control units (with each controlling a separate UAV), the described technologies can enable multiple UAVs 120A-C to be collectively and/or individually controlled and/or otherwise configured via a single device 110, as described herein.

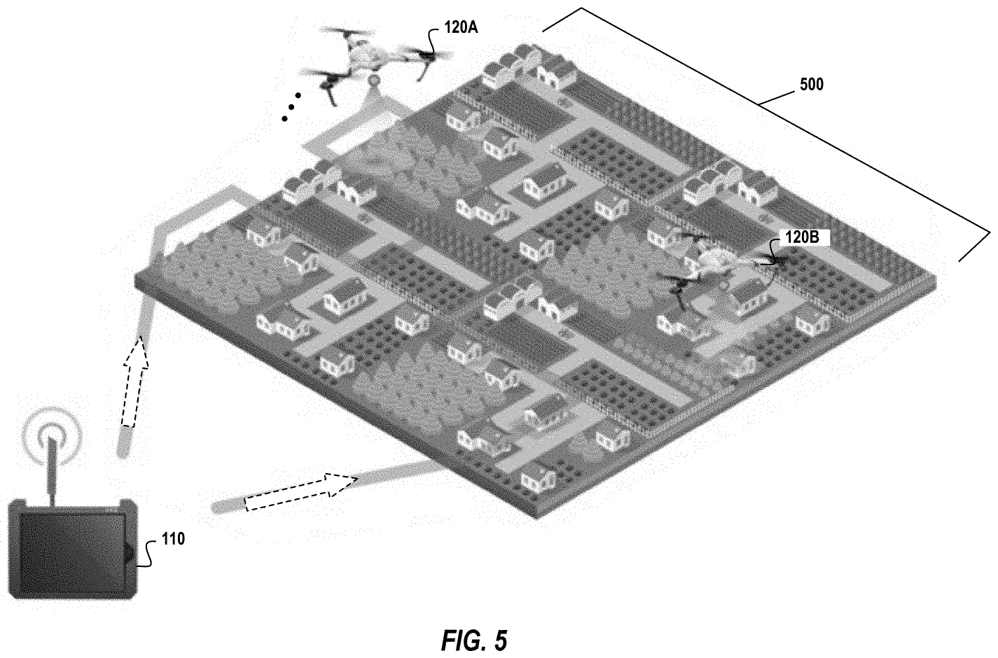

By way of further illustration, FIG. 5 depicts and scenario in which device 110 (e.g., a control unit or other such device configured to control and/or monitor the operations, status, etc., of multiple UAVs 120) can configure UAVs 120A and 120B to collectively complete a mission or task. Such a mission or task can include, for example, performing surveillance or monitoring on a large geographic area. By way of illustration, as shown in FIG. 5, the various UAVs 120A, 120B, etc. can be respectively configured to perform a segment of the mission (e.g., to perform surveillance on a area 500, such as a town, city, other geographic area or region, etc.). The information collected by each respective UAV 120 can be relayed back to device 110. For example, as shown, UAV 120A can be configured, directed, etc. to perform surveillance on one portion or segment of an area, while UAV 120B can be configured, directed, etc. to perform surveillance on one portion or segment of an area, The described technologies (e.g., device 110) can then combine, aggregate, integrate, etc. the collective information (e.g., as received from multiple UAVs) to complete the surveillance/analysis of the entire area.

In certain implementations, the described technologies can be configured to dynamically select and/or adjust the selection of the referenced ‘master’ UAV/device. For example, in certain implementations the UAV determined to be closest and/or capable of most consistent communication with to the control unit (e.g., device 110) can be selected as the ‘master’ UAV, with the other UAVs establishing direct/indirect connections to such ‘master.’ In various circumstances, scenarios, etc., other UAVs or device can subsequently be substituted for such ‘master.’ For example, in a scenario in which another UAV is determined to be closer and/or capable of a more consistent connection to the device 110, such a UAV can be substituted as the “master.” By way of further example, in a scenario in which an initially selected ‘master’ UAV is determined to be running low on power or otherwise malfunctioning, another UAV can be selected to be substituted as a ‘master.’ Doing so can be advantageous, for example, in order to enable the connection/control of the other UAVs (by device 110) to remain consistent.

The described technologies can be particularly advantageous when implemented in relation to scenarios in which certain operations/missions (e.g., surveillance) are to be performed with respect to defined or particular point(s) of interest over an extended period of time (e.g., 24 hours). In view of power/battery limitations, a single UAV may not be able to complete such a task. Accordingly, the described technologies can be configured to utilize one UAV with respect to one segment of a mission (e.g., during one chronological interval) and then substituting or “swapping” it with another UAV (e.g., when the battery of the first UAV is low).

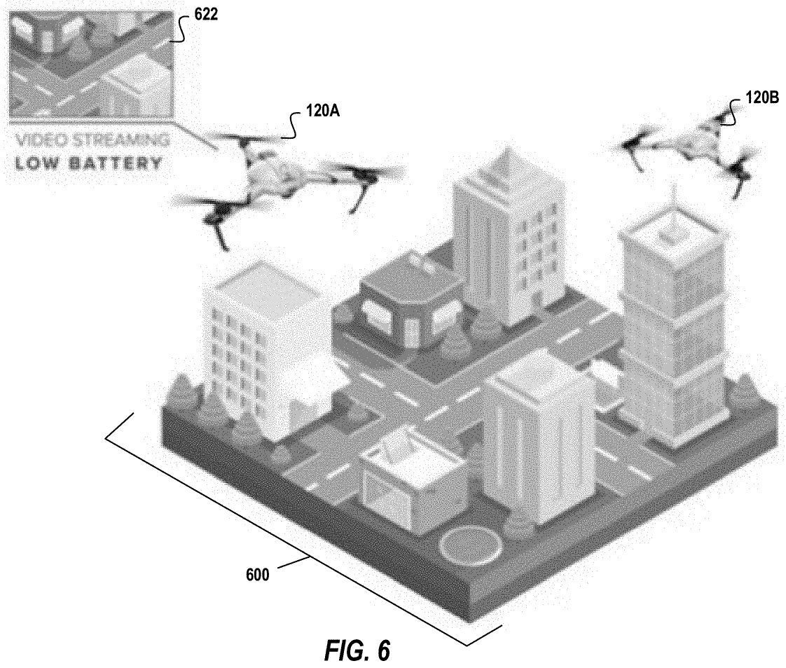

By way of illustration, FIG. 6 depicts an example scenario in which a UAV initially selected to be a ‘master’ (here, UAV 120A) is running low on battery and may be further configured to provide ongoing video surveillance 622 of a particular area (e.g., intersection or area 600, as shown). In such a scenario, based on such a determination with respect to UAV 120A, UAV 120B can be routed to the depicted area and/or can be substituted for UAV 120A. In doing so, UAV 120B can be selected or designated as the ‘master’ device or node, and can further enable continuous ongoing communication to multiple other UAVs (not shown), as well as ensuring continuity of the operation(s) previously performed by UAV 120A.

Moreover, in certain implementations, the described technologies can be configured by initially connecting multiple UAVs to device/control unit 110 and selecting point(s) of interest to monitor. The described technologies can then utilize the connected UAVs individually, by first dispatching one UAV, and then substituting another when the battery of the first UAV is getting low. In order to enable such a substitution, the status of each UAV is to be monitored, as well as various other conditions, circumstances, etc. (e.g., wind, light levels, range, etc.). Additionally, in certain implementations the described technologies may maintain a single video/stream of such surveillance footage (as captured by multiple UAVs in sequence). Accordingly, upon determining that one UAV is being substituted for another, the described technologies can change the source of such a video feed/stream to the second UAV.

Moreover, in certain implementations each of several UAVs (which may be deployed simultaneously in different locations) may be capable of capturing and/or transmitting real-time video. However, in certain scenarios, such as those in which a single UAV is configured to receive data from multiple UAVs, bandwidth limitations may make it difficult to transmit full resolution real-time feeds from each UAV. Accordingly, in certain implementations the described technologies can further include various dynamic compression/decompression features. Such technologies can, for example, enable the communication and/or relay of such captured real-time vides (and/or other information) to device/control unit 110.

In certain implementations, such technologies can compress captured videos at the UAV, and then relay such compressed content to the device 110 via one or more other UAVs (where such videos can be decompressed), as described herein. Additionally, in certain implementations the described technologies can be further configured to select or determine which of several received videos is to be relayed in a high-quality format, and which videos are to be relayed in lower quality formats. Doing so can utilize existing bandwidth to simultaneously transmit videos originating from multiple UAVs. Being that user 130 is unlikely to be capable of viewing more than a few (e.g., 2 or 3) video streams simultaneously, the described technologies can be configured to determined which stream(s), video(s), or video source(s) are likely to be currently (or prospectively) viewed by the user. Such identified video streams can be prioritized (e.g., transmitted across the described network of UAVs in high definition) with the others being transmitted in lower resolution. The user can still view such lower resolution video streams, and the described technologies can further adjust such configuration such that other streams can be prioritized as the user's viewing/interaction with such streams changes (and/or based on other factors, e.g., degradation of quality in the initially selected streams, increase in quality in the lower quality streams, other identified events/occurrences, etc.).

Moreover, in certain implementations the described technologies can be further configured to provide various dynamic user interface(s) (e.g., at device/control unit 110). Such user interfaces can, for example, enable user 130 to view the described content/information, control one or more of the described UAVs, and/or initiate other actions/operations described herein.

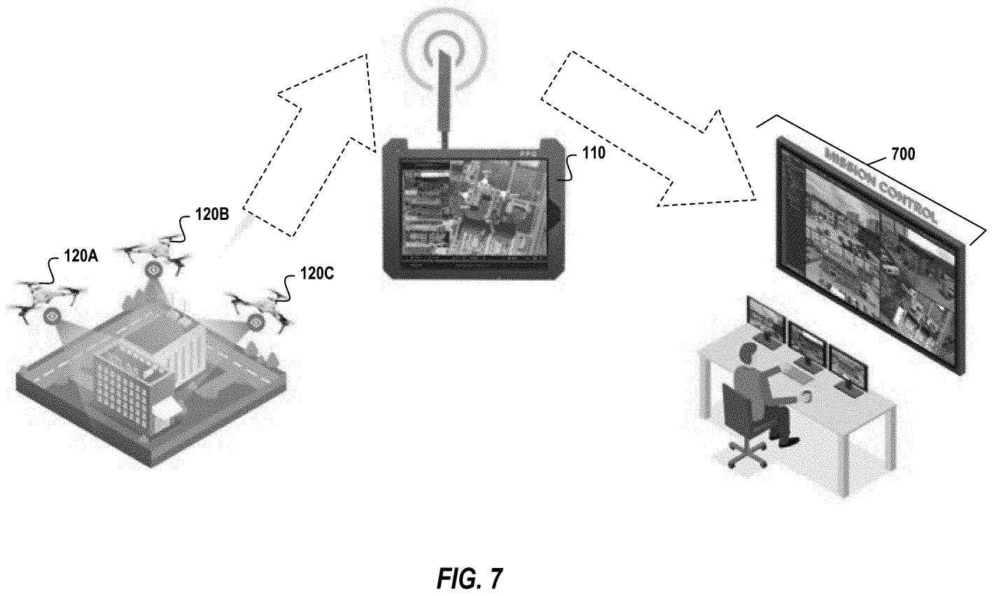

For example, in certain implementations the described device 110 can be configured to provide or enable various user interfaces through which user 130 can quickly switch or ‘jump’ between viewing content (e.g., video streams) originating from different UAVs. In other implementations, such content can be presented in various interfaces that enable simultaneous viewing of multiple streams. For example, FIG. 7 depicts a scenario in which multiple UAVs 120A-C transmit content to device 110, and such content is related to a ‘mission control’ center 700 capable of monitoring multiple video streams simultaneously.

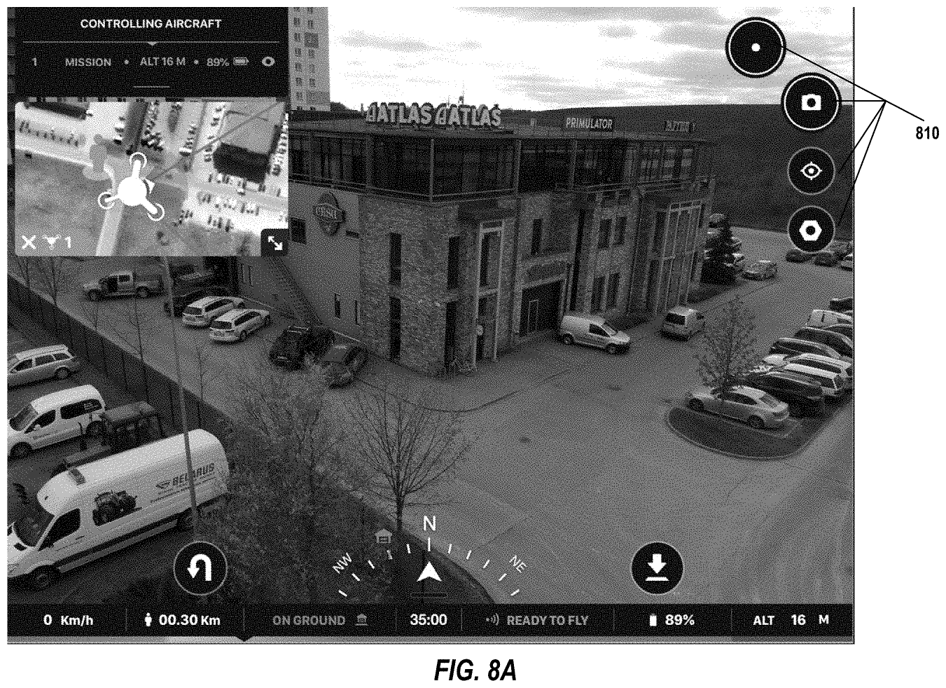

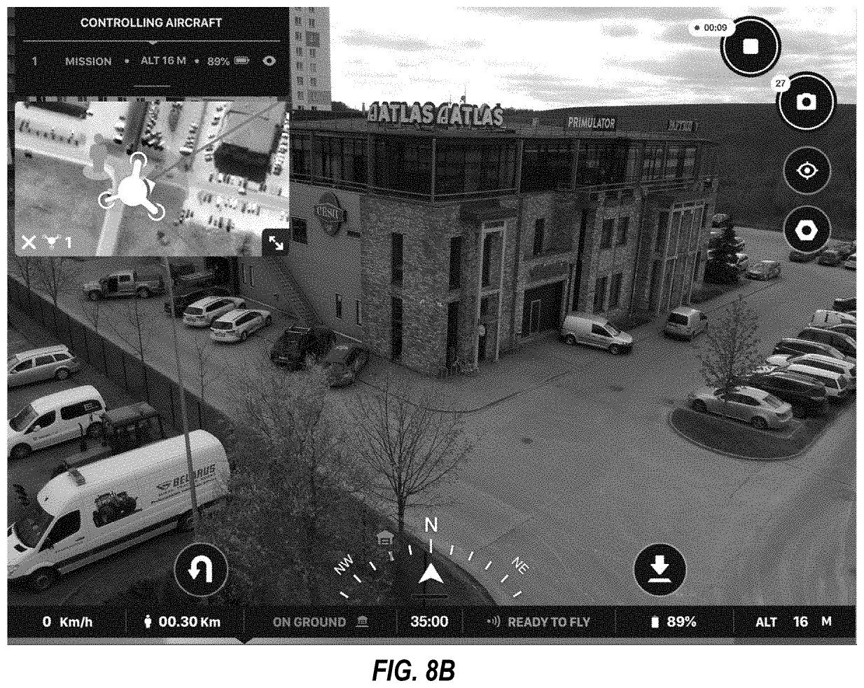

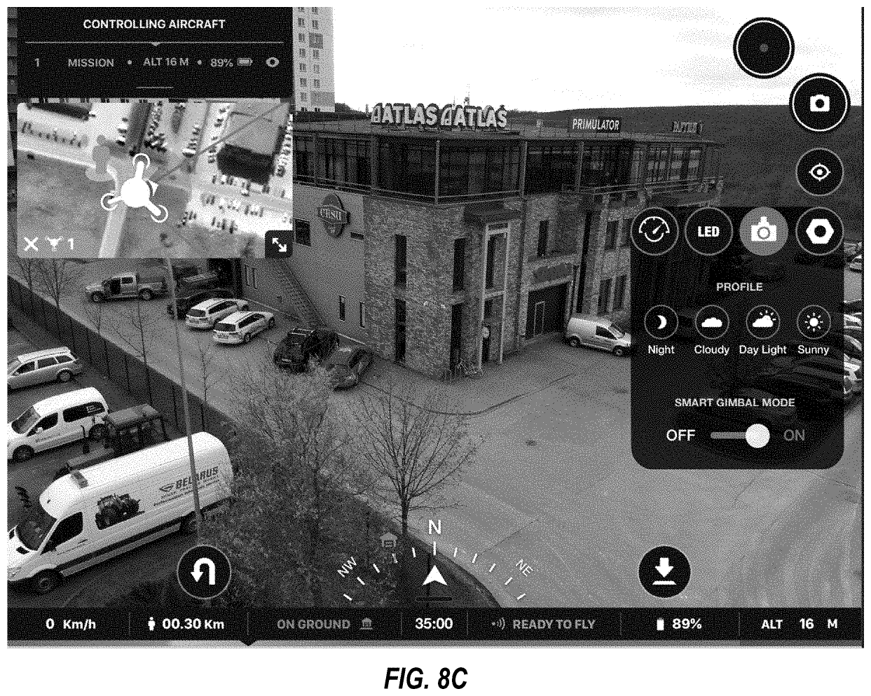

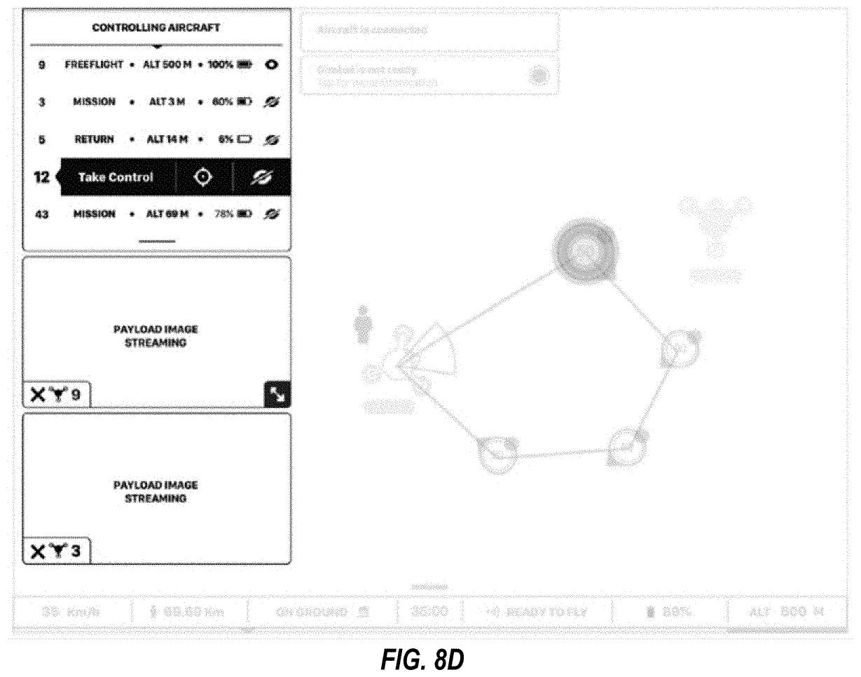

FIGS. 8A-8D depict further aspects of the described user interfaces, such as may be implemented at device 110. As shown in FIGS. 8A-8D, various selectable buttons/controls (e.g., controls 810) can be presented, e.g., at a display of device 110. The selection of/interaction with such controls can, for example, enable user 130 to start/stop video recordings originating from a selected UAV, and/or perform other operations (e.g., take snapshots, select point of interest, access camera settings, etc.). In certain implementations, such inputs can be provided by user 130 via a touchscreen interface, e.g., by the user sliding his/her finger across portions of the screen. In certain implementations, the camera settings can be implemented as a ‘floating’ menu that expands/collapses (e.g., as shown in FIG. 8C). Additionally, in certain implementations the described interfaces can enable a user to select from among several available UAVs or video streams, e.g., as depicted in FIG. 8D. In certain implementations, the described user interface(s) can be adjusted to reflect capabilities of the payload utilized by a given UAV. Such adaptation can include, for example, the use of a ‘flying’ bar for special setting adjustments.

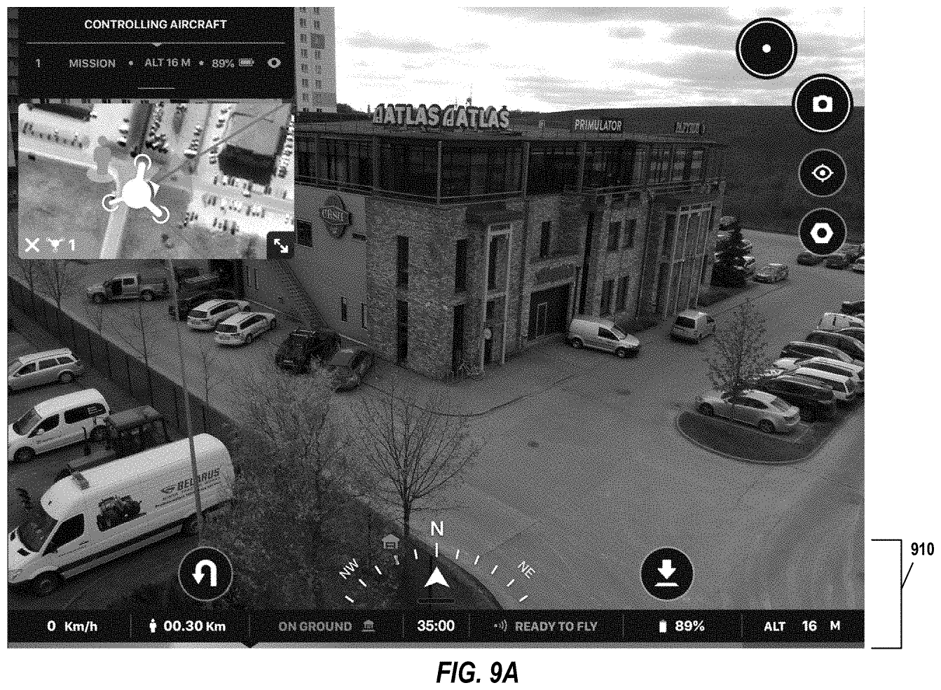

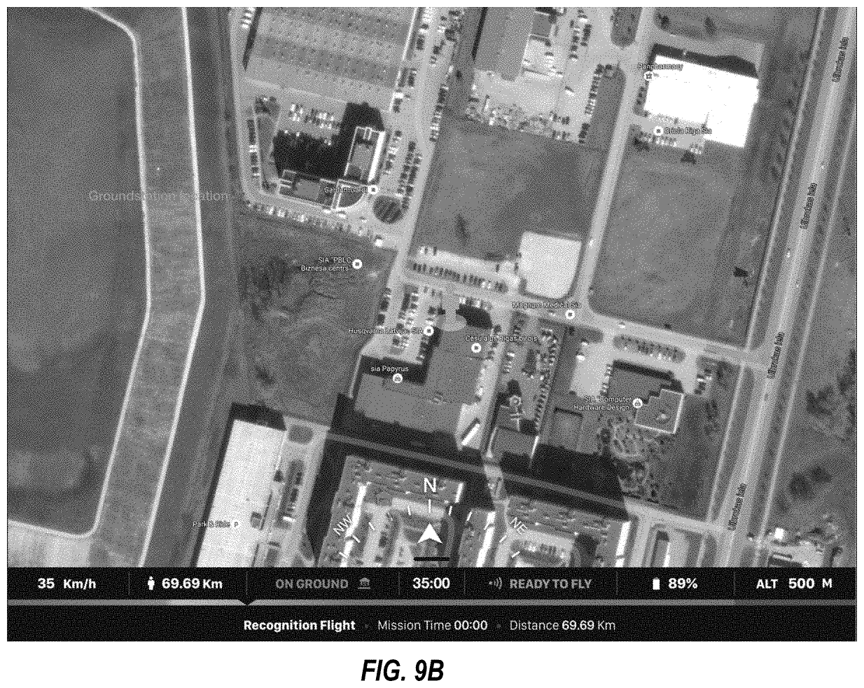

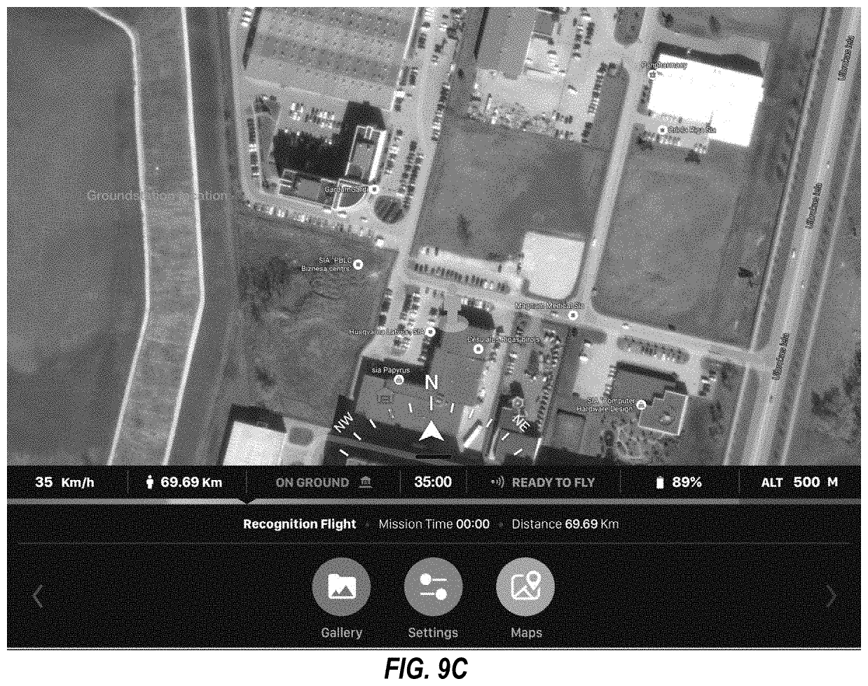

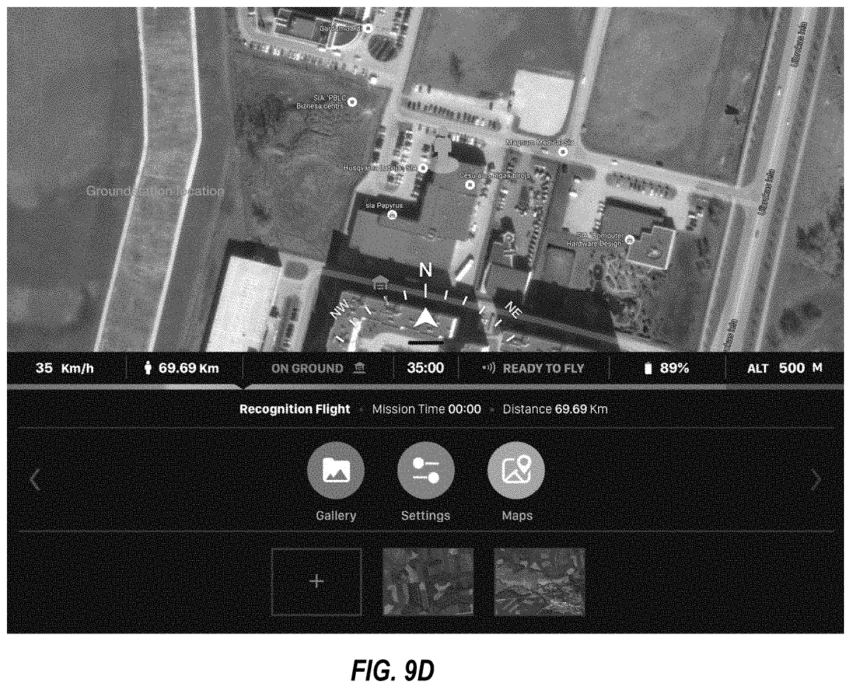

FIGS. 9A-9D depict further aspects of the described user interfaces (including the referenced ‘flying’ bar), such as may be implemented at device 110. As shown in FIGS. 9A-9D, such interface controls can enable user 130 to access more information about a UAV, ground station, payloads, previous missions, maps information, etc. For example, such an interface element or ‘bar’ 910 (e.g., as shown in FIG. 9A) can depict various UAV/flying data such as: speed, distance, mission type, flying time remaining, status, battery, altitude, etc. (e.g., with respect to a particular UAV). Additionally, by sliding or ‘swiping’ in different directions via a touchscreen interface of device 110 (e.g., swiping up from the bottom of the screen), various menus/controls can be revealed, as shown (e.g., in FIGS. 9C and 9D).

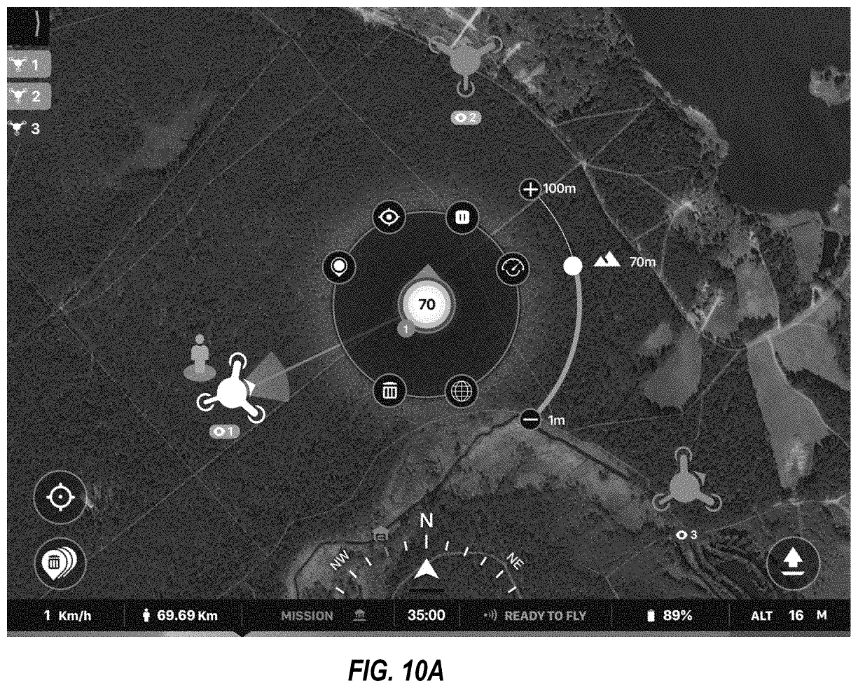

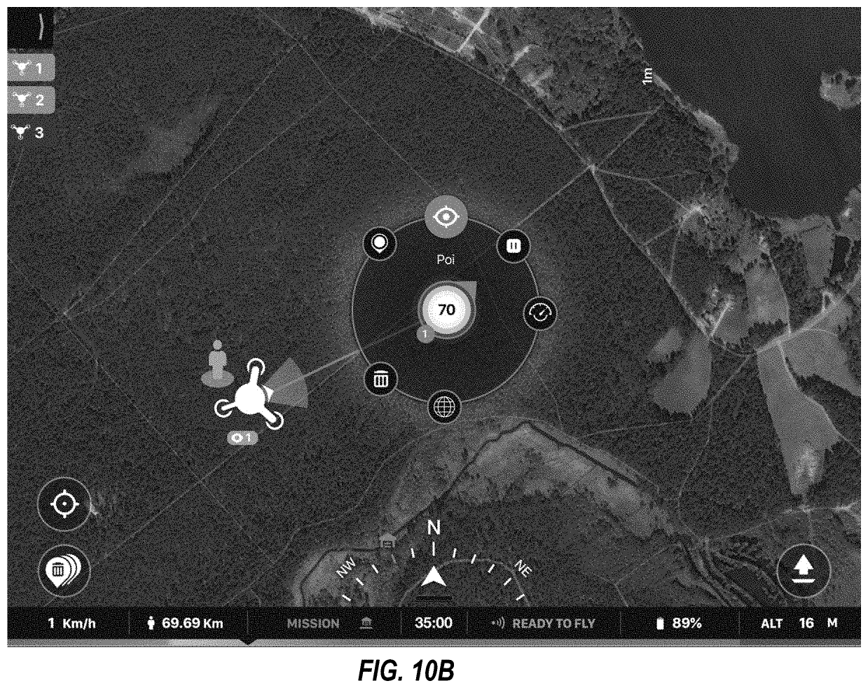

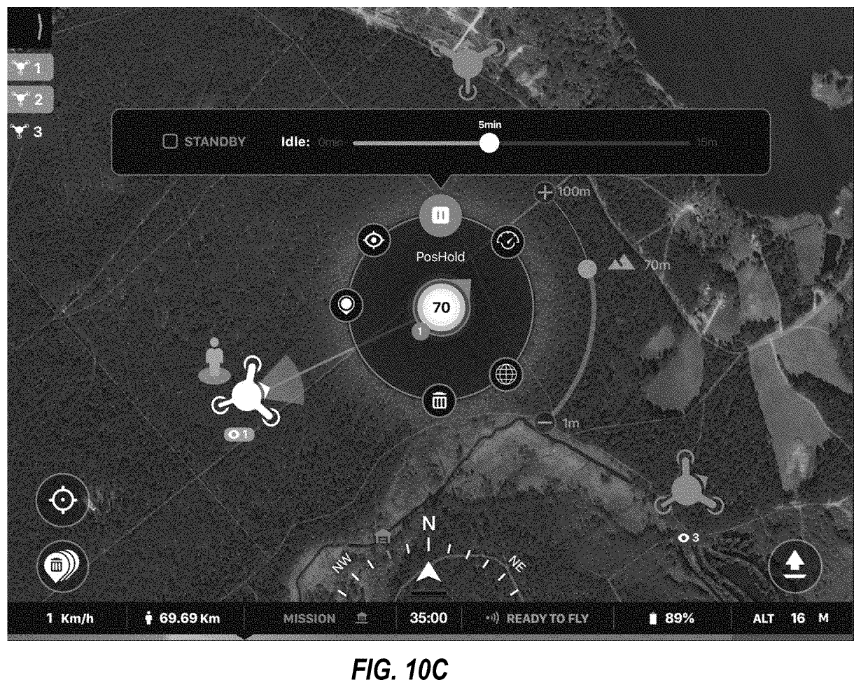

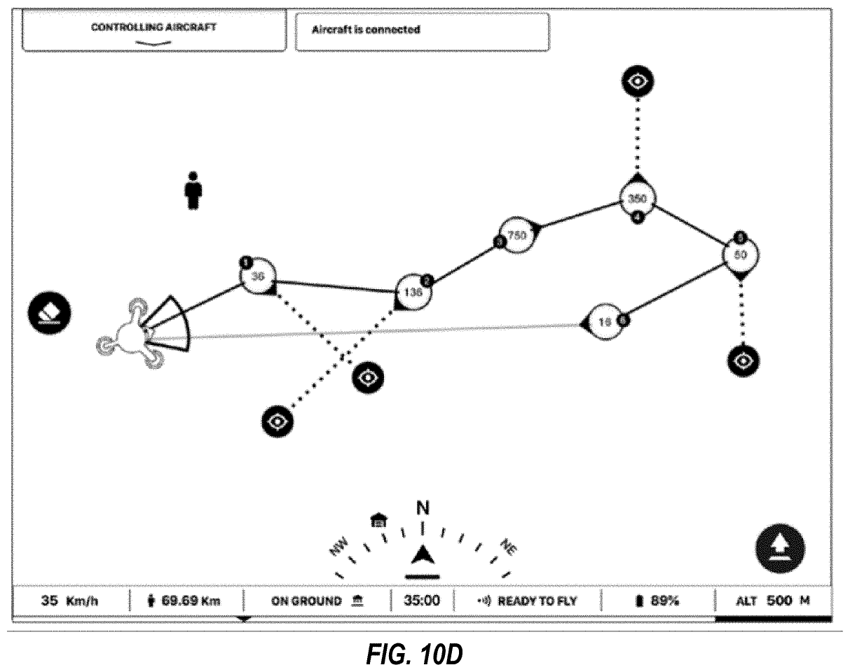

FIGS. 10A-10D depict further aspects of the described user interfaces, such as may be implemented at device 110. As shown in FIGS. 10A-10D, the described user interfaces can enable user 130 to define various navigation/mission paths and/or other operations to be performed by one or more UAVs (e.g., in relation to certain geographic areas). For example, user 130 can utilize an interface (e.g., a touchscreen interface) of device 110 to define one or more waypoints, and/or to further define certain operations (e.g., capture a picture, video, etc.) and/or parameters (e.g., altitude, camera settings, etc.) with respect to which such operations are to be performed. The user can also assign such operations to a particular UAV and/or enable the described technologies to dynamically assign such commands to one or more UAV(s) (e.g., based on availability, capabilities, etc.).

It can therefore be appreciated that the described technologies provide numerous technical advantages and improvements over existing technologies. For example, the described technologies enable a single user to configure and/or control the operation of multiple UAVs operating simultaneously. Additionally, the described technologies enable multiple UAVs to connect to one another to extend the range such UAVs can travel from a control device. The described technologies also enable additional features and functionalities that provide operational efficiencies and advantages, e.g., to leverage the capabilities of multiple UAVs to perform various tasks, missions, etc., as described herein.

It should also be noted that while the technologies described herein are illustrated primarily with respect to UAV configuration and control, the described technologies can also be implemented in any number of additional or alternative settings or contexts and towards any number of additional objectives.

Certain implementations are described herein as including logic or a number of components, modules, or mechanisms. Modules can constitute either software modules (e.g., code embodied on a machine-readable medium) or hardware modules. A “hardware module” is a tangible unit capable of performing certain operations and can be configured or arranged in a certain physical manner. In various example implementations, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some implementations, a hardware module can be implemented mechanically, electronically, or any suitable combination thereof. For example, a hardware module can include dedicated circuitry or logic that is permanently configured to perform certain operations. For example, a hardware module can be a special-purpose processor, such as a Field-Programmable Gate Array (FPGA) or an Application Specific Integrated Circuit (ASIC). A hardware module can also include programmable logic or circuitry that is temporarily configured by software to perform certain operations. For example, a hardware module can include software executed by a programmable processor. Once configured by such software, hardware modules become specific machines (or specific components of a machine) uniquely tailored to perform the configured functions. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering implementations in which hardware modules are temporarily configured (e.g., programmed), each of the hardware modules need not be configured or instantiated at any one instance in time. For example, where a hardware module comprises a processor configured by software to become a special-purpose processor, the processor can be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In implementations in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API).

The performance of certain of the operations can be distributed among the processors, not only residing within a single machine, but deployed across a number of machines. In some example implementations, the processors or processor-implemented modules can be located in a single geographic location (e.g., within a home environment, an office environment, or a server farm). In other example implementations, the processors or processor-implemented modules can be distributed across a number of geographic locations.

The modules, methods, applications, and so forth described in conjunction with FIGS. 1-10D are implemented in some implementations in the context of a machine and an associated software architecture. The sections below describe representative software architecture(s) and machine (e.g., hardware) architecture(s) that are suitable for use with the disclosed implementations.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture can yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

FIG. 11 is a block diagram illustrating components of a machine 1100, according to some example implementations, able to read instructions from a machine-readable medium (e.g., a machine-readable storage medium) and perform any one or more of the methodologies discussed herein. Specifically, FIG. 11 shows a diagrammatic representation of the machine 1100 in the example form of a computer system, within which instructions 1116 (e.g., software, a program, an application, an applet, an app, or other executable code) for causing the machine 1100 to perform any one or more of the methodologies discussed herein can be executed. The instructions 1116 transform the non-programmed machine into a particular machine programmed to carry out the described and illustrated functions in the manner described. In alternative implementations, the machine 1100 operates as a standalone device or can be coupled (e.g., networked) to other machines. In a networked deployment, the machine 1100 can operate in the capacity of a server machine or a client machine in a server-client network environment, or as a peer machine in a peer-to-peer (or distributed) network environment. The machine 1100 can comprise, but not be limited to, a server computer, a client computer, PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1116, sequentially or otherwise, that specify actions to be taken by the machine 1100. Further, while only a single machine 1100 is illustrated, the term “machine” shall also be taken to include a collection of machines 1100 that individually or jointly execute the instructions 1116 to perform any one or more of the methodologies discussed herein.

The machine 1100 can include processors 1110, memory/storage 1130, and I/O components 1150, which can be configured to communicate with each other such as via a bus 1102. In an example implementation, the processors 1110 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) can include, for example, a processor 1112 and a processor 1114 that can execute the instructions 1116. The term “processor” is intended to include multi-core processors that can comprise two or more independent processors (sometimes referred to as “cores”) that can execute instructions contemporaneously. Although FIG. 11 shows multiple processors 1110, the machine 1100 can include a single processor with a single core, a single processor with multiple cores (e.g., a multi-core processor), multiple processors with a single core, multiple processors with multiples cores, or any combination thereof.

The memory/storage 1130 can include a memory 1132, such as a main memory, or other memory storage, and a storage unit 1136, both accessible to the processors 1110 such as via the bus 1102. The storage unit 1136 and memory 1132 store the instructions 1116 embodying any one or more of the methodologies or functions described herein. The instructions 1116 can also reside, completely or partially, within the memory 1132, within the storage unit 1136, within at least one of the processors 1110 (e.g., within the processor's cache memory), or any suitable combination thereof, during execution thereof by the machine 1100. Accordingly, the memory 1132, the storage unit 1136, and the memory of the processors 1110 are examples of machine-readable media.

As used herein, “machine-readable medium” means a device able to store instructions (e.g., instructions 1116) and data temporarily or permanently and can include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 1116. The term “machine-readable medium” shall also be taken to include any medium, or combination of multiple media, that is capable of storing instructions (e.g., instructions 1116) for execution by a machine (e.g., machine 1100), such that the instructions, when executed by one or more processors of the machine (e.g., processors 1110), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1150 can include a wide variety of components to receive input, provide output, produce output, transmit information, exchange information, capture measurements, and so on. The specific I/O components 1150 that are included in a particular machine will depend on the type of machine. For example, portable machines such as mobile phones will likely include a touch input device or other such input mechanisms, while a headless server machine will likely not include such a touch input device. It will be appreciated that the I/O components 1150 can include many other components that are not shown in FIG. 11. The I/O components 1150 are grouped according to functionality merely for simplifying the following discussion and the grouping is in no way limiting. In various example implementations, the I/O components 1150 can include output components 1152 and input components 1154. The output components 1152 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1154 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example implementations, the I/O components 1150 can include biometric components 1156, motion components 1158, environmental components 1160, or position components 1162, among a wide array of other components. For example, the biometric components 1156 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1158 can include acceleration sensor components (e.g., accelerometer), gravitation sensor components, rotation sensor components (e.g., gyroscope), and so forth. The environmental components 1160 can include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that can provide indications, measurements, or signals corresponding to a surrounding physical environment. The position components 1162 can include location sensor components (e.g., a Global Position System (GPS) receiver component), altitude sensor components (e.g., altimeters or barometers that detect air pressure from which altitude can be derived), orientation sensor components (e.g., magnetometers), and the like.

Communication can be implemented using a wide variety of technologies. The I/O components 1150 can include communication components 1164 operable to couple the machine 1100 to a network 1180 or devices 1170 via a coupling 1182 and a coupling 1172, respectively. For example, the communication components 1164 can include a network interface component or other suitable device to interface with the network 1180. In further examples, the communication components 1164 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1170 can be another machine or any of a wide variety of peripheral devices (e.g., a peripheral device coupled via a USB).

Moreover, the communication components 1164 can detect identifiers or include components operable to detect identifiers. For example, the communication components 1164 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information can be derived via the communication components 1164, such as location via Internet Protocol (IP) geolocation, location via Wi-Fi® signal triangulation, location via detecting an NFC beacon signal that can indicate a particular location, and so forth.

In various example implementations, one or more portions of the network 1180 can be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1180 or a portion of the network 1180 can include a wireless or cellular network and the coupling 1182 can be a Code Division Multiple Access (CDMA) connection, a Global System for Mobile communications (GSM) connection, or another type of cellular or wireless coupling. In this example, the coupling 1182 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 11G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1116 can be transmitted or received over the network 1180 using a transmission medium via a network interface device (e.g., a network interface component included in the communication components 1164) and utilizing any one of a number of well-known transfer protocols (e.g., HTTP). Similarly, the instructions 1116 can be transmitted or received using a transmission medium via the coupling 1172 (e.g., a peer-to-peer coupling) to the devices 1170. The term “transmission medium” shall be taken to include any intangible medium that is capable of storing, encoding, or carrying the instructions 1116 for execution by the machine 1100, and includes digital or analog communications signals or other intangible media to facilitate communication of such software.

Throughout this specification, plural instances can implement components, operations, or structures described as a single instance. Although individual operations of one or more methods are illustrated and described as separate operations, one or more of the individual operations can be performed concurrently, and nothing requires that the operations be performed in the order illustrated. Structures and functionality presented as separate components in example configurations can be implemented as a combined structure or component. Similarly, structures and functionality presented as a single component can be implemented as separate components. These and other variations, modifications, additions, and improvements fall within the scope of the subject matter herein.

Although an overview of the inventive subject matter has been described with reference to specific example implementations, various modifications and changes can be made to these implementations without departing from the broader scope of implementations of the present disclosure. Such implementations of the inventive subject matter can be referred to herein, individually or collectively, by the term “invention” merely for convenience and without intending to voluntarily limit the scope of this application to any single disclosure or inventive concept if more than one is, in fact, disclosed.

The implementations illustrated herein are described in sufficient detail to enable those skilled in the art to practice the teachings disclosed. Other implementations can be used and derived therefrom, such that structural and logical substitutions and changes can be made without departing from the scope of this disclosure. The Detailed Description, therefore, is not to be taken in a limiting sense, and the scope of various implementations is defined only by the appended claims, along with the full range of equivalents to which such claims are entitled.

As used herein, the term “or” can be construed in either an inclusive or exclusive sense. Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various implementations of the present disclosure. In general, structures and functionality presented as separate resources in the example configurations can be implemented as a combined structure or resource. Similarly, structures and functionality presented as a single resource can be implemented as separate resources. These and other variations, modifications, additions, and improvements fall within a scope of implementations of the present disclosure as represented by the appended claims. The specification and drawings are, accordingly, to be regarded in an illustrative rather than a restrictive sense.

1. A system comprising:
a processing device; and
a memory coupled to the processing device and storing instructions that, when executed by the processing device, cause the system to perform operations comprising:
receiving, at a first unmanned aerial vehicle (“UAV”), one or more commands;
receiving, at the first UAV, a location update associated with a second UAV;
processing the location update to compute a location of the first UAV in relation to the second UAV; and
initiating one or more operations in relation to the one or more commands based on the computed location of the first UAV in relation to the second UAV.

2. The system of claim 1, wherein the location update comprises one or more inputs originating from one or more sensors of the second UAV.

3. The system of claim 1, wherein receiving a location update associated with a second UAV further comprises receiving a location update associated with a third UAV.

4. The system of claim 1, wherein receiving a location update comprises receiving one or more location updates from one or more UAVs within communication range of the first UAV.

5. The system of claim 1, wherein receiving a location update associated with a second UAV comprises receiving the location update from the second UAV.

6. The system of claim 1, wherein processing the location update comprises processing one or more location updates received from one or more UAVs to compute a location of the first UAV in relation to the one or more UAVs.

7. The system of claim 1, wherein processing the location update comprises processing the location update to compute, at the first UAV, a real-time map reflecting a location of the first UAV in relation to one or more respective locations of one or more other UAVs.

8. The system of claim 1, wherein receiving one or more commands comprises:
receiving one or more commands directed to one or more UAVs;
processing the one or more commands to generate one or more instructions with respect to at least one of the one or more UAVs; and
distributing at least one of the one or more instructions to at least one of the one or more UAVs.

9. The system of claim 1, wherein initiating one or more operations comprises initiating one or more operations configured to prevent the first UAV from colliding with one or more other UAVs.

10. The system of claim 1, wherein initiating one or more operations comprises initiating one or more safety operations with respect the first UAV in relation to one or more other UAVs.

11. The system of claim 1, wherein the memory further stores instructions to cause the system to perform operations comprising: providing a location update associated with the first UAV to one or more other UAVs.

12. A method comprising:
receiving, at a first unmanned aerial vehicle (“UAV”), one or more commands;
receiving, at the first UAV, a location update associated with a second UAV, the location update comprising one or more inputs originating from one or more sensors of the second UAV;
processing the location update to compute a location of the first UAV in relation to the second UAV; and
initiating one or more operations in relation to the one or more commands based on the computed location of the first UAV in relation to the second UAV.

13. The method of claim 12, wherein receiving a location update associated with a second UAV further comprises receiving a location update associated with a third UAV.

14. The method of claim 12, wherein receiving a location update comprises receiving one or more location updates from one or more UAVs within communication range of the first UAV.

15. The method of claim 12, wherein receiving a location update associated with a second UAV comprises receiving the location update from the second UAV.

16. The method of claim 12, wherein processing the location update comprises at least one of: (a) processing one or more location updates received from one or more UAVs to compute a location of the first UAV in relation to the one or more UAVs, or (b) processing the location update to compute, at the first UAV, a real-time map reflecting a location of the first UAV in relation to one or more respective locations of one or more other UAVs.

17. (canceled)

18. The method of claim 12, wherein receiving one or more commands comprises:
receiving one or more commands directed to one or more UAVs;
processing the one or more commands to generate one or more instructions with respect to at least one of the one or more UAVs; and
distributing at least one of the one or more instructions to at least one of the one or more UAVs.

19. The method of claim 12, wherein initiating one or more operations comprises at least one of: (a) initiating one or more operations configured to prevent the first UAV from colliding with one or more other UAVs, or (b) initiating one or more safety operations with respect the first UAV in relation to one or more other UAVs.

20. (canceled)

21. (canceled)

23. A non-transitory computer readable medium having instructions stored thereon that, when executed by a processing device, cause the processing device to perform operations comprising:
receiving, at a first unmanned aerial vehicle (“UAV”), one or more commands;
receiving, at the first UAV, a location update associated with a second UAV, the location update comprising one or more inputs originating from one or more sensors of the second UAV;
processing the location update to compute, at the first UAV, a location of the first UAV in relation to the second UAV and a third UAV; and
initiating one or more operations in relation to the one or more commands based on the computed location of the first UAV in relation to the second UAV and the third UAV.
